(19) United States
(12) Patent Application Publication
(10) Pub. No.: US 2009/0214953 A1
(43) Pub. Date: Aug. 27, 2009

(54) HYDROGEN STORAGE ALLOY, HYDROGEN STORAGE ALLOY ELECTRODE AND NICKEL METAL HYDRIDE SECONDARY BATTERY USING THE HYDROGEN STORAGE ALLOY

(75) Inventors: Masaru KIHARA, Moriguchi-shi (JP); Takahiro ENDO, Takasaki-shi (JP); Akira SAGUCHI, Takasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/392,518

(22) Filed: Feb. 25, 2009

(30) Foreign Application Priority Data
Feb. 26, 2008 (JP) 2008-044082

(51) Int. Cl. H01M 4/58; C22C 23/06; H01M 4/52

(52) U.S. Cl. 429/218.2; 420/405; 420/406; 429/223

(57) ABSTRACT

A nickel metal hydride secondary battery includes hydrogen storage alloy particles in a negative electrode. The hydrogen storage alloy has a composition expressed by a general formula (LaₐSm_{b}Gd_{c}“A”_{d})_{1-w}Mg_{w}NiₓAl_{y}“T”_{z}, where “A” and “T” each represent at least one element selected from a group consisting of Pr, Nd, etc., and a group consisting of V, Nb, etc., respectively; subscripts a, b, c and d satisfy relationship expressed by a>0, b≧0, c>0, 0.1>d≧0, and a+b+c+d=1; and subscripts w, x, y and z fall in a range expressed by 0.1≦w≦0.3, 0.05≦y≦0.35, 0≦z≦0.5, and 3.2≦x+y+z≦3.8.

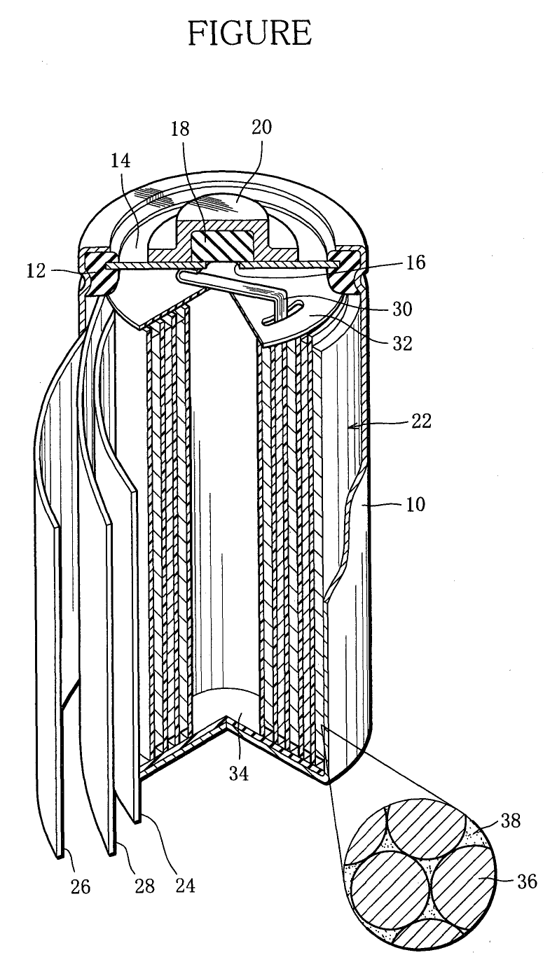

### BACKGROUND OF THE INVENTION

1. Field of the Invention

The present invention relates to hydrogen storage alloy, a hydrogen storage alloy electrode and a nickel metal hydride secondary battery using the hydrogen storage alloy.

2. Description of the Related Art

It has been proposed to use a rare-earth-Mg—Ni-based hydrogen storage alloy in a negative active material of an electrode to achieve the high performance of a nickel metal hydride secondary battery. The rare-earth-Mg—Ni-based hydrogen storage alloy has a larger hydrogen storage amount than rare-earth-Ni-based hydrogen storage alloy that has been conventionally used, and is therefore suitable to achieve the high capacity of a nickel metal hydride secondary battery.

On the other hand, the rare-earth-Mg—Ni-based hydrogen storage alloy has a low resistance to alkali. A nickel metal hydride secondary battery using this alloy has a disadvantage such as a small amount of times that the battery is allowed to be charged/discharged, namely, a short cycle life.

In order to solve this problem, various suggestions have been made, taking account of rare-earth components. For example, Document 1 (U.S. Pat. No. 3,913,691) and Document 2 (Unexamined Japanese Patent Publication No. 2005-290473) disclose reducing La content and increasing Pr and Nd contents.

The inventors of the present invention suggest, in the previous application, a rare-earth-Mg—Ni-based hydrogen storage alloy that has a given composition including La and Sm and contains a large content of La and a small content of Pr and Nd (Patent Application No. 2007-283071).

The rare-earth-Mg—Ni-based hydrogen storage alloy disclosed in Documents 1 and 2 has an excellent resistance to alkali. A nickel metal hydride secondary battery using this alloy has a long cycle life.

However, as to the rare-earth-Mg—Ni-based hydrogen storage alloy disclosed in Documents 1 and 2, an allowable amount of hydrogen storage is reduced, and hydrogen equilibrium pressure is increased. The inner pressure of the battery is therefore liable to increase. This results from the decrease of the La content.

The rare-earth-Mg—Ni-based hydrogen storage alloy described in the previous application also has an excellent resistance to alkali. A nickel metal hydride secondary battery using this alloy, which is mentioned in the previous application, has a long cycle life.

However, if the nickel metal hydride secondary battery of the previous application is used after being left in a high-temperature environment, various battery characteristics including the long cycle life are deteriorated. When the nickel metal hydride secondary battery is transported by ship or vehicle, there is the fear that the battery is exposed to a high-temperature environment during the transportation. It is then important to previously solve the problems caused by the high-temperature environment.

### SUMMARY OF THE INVENTION

It is an object of the invention to provide a rare-earth-Mg—Ni-based hydrogen storage alloy that is excellent in alkali resistance in a high-temperature environment, and a hydrogen storage alloy electrode using the alloy, and to provide a nickel metal hydride secondary battery that uses the rare-earth-Mg—Ni-based hydrogen storage alloy and is thus suppressed from being deteriorated in battery characteristics even if left in a high-temperature environment.

The hydrogen storage alloy provided by the invention has a composition expressed by a general formula:

(LaₐSm_{b}Gd_{c}“A”_{d})_{1-w}Mg_{w}NiₓAl_{y}“T”_{z}

where “A” represents at least one element selected from a group consisting of Pr, Nd, Eu, Tb, Dy, Ho, Er, Tm, Yb, Lu, Sc, Zr, Hf, Ca and Y; “T” represents at least one element selected from a group consisting of V, Nb, Ta, Cr, Mo, Mn, Fe, Co, Ga, Zn, Sn, In, Cu, Si, P and B; subscripts a, b, c and d satisfy relationship shown by a>0, b≧0, c≧0, 0.1>d≧0, and a+b+c+d=1; and subscripts w, x, y and z fall within a range shown by 0.1≦w≦0.3, 0.05≦y≦0.35, 0≦z≦0.5, and 3.2≦x+y+z≦3.8.

Since the composition of the hydrogen storage alloy of the invention contains La and Gd, the hydrogen storage alloy is excellent in alkali resistance even in a high-temperature environment.

The invention provides the hydrogen storage alloy electrode, which includes a core member having conductivity and a particle carried by the core member. The particle is made of the hydrogen storage alloy.

The electrode of the invention is therefore excellent in alkali resistance even in a high-temperature environment.

The invention further provides the nickel metal hydride secondary battery. The battery has the hydrogen storage alloy electrode as a negative electrode, a positive electrode, and alkaline electrolyte.

Since the nickel metal hydride secondary battery of the invention has the hydrogen storage alloy electrode containing the hydrogen storage alloy, the battery has a long cycle life even if left in the high-temperature environment.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirits and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIGURE is a perspective view partially broken away, showing a nickel metal hydride secondary battery according to one embodiment of the invention, and schematically showing a part of a negative electrode in enlarged scale within a circle.

### DETAILED DESCRIPTION OF THE PREFERRED EMBODIMENTS

In order to accomplish the above-mentioned object, the inventors have a keen examination of means for securing an alkali resistance of a rare-earth-Mg—Ni-based hydrogen storage alloy in a high-temperature environment. Through the examination, the inventors found that a sufficient alkali resistance can be secured even in the high-temperature environment if La and Gd are contained in the rare-earth-Mg—Ni-based hydrogen storage alloy. The inventors thus conceived of the present invention.

With reference to FIGURE, the nickel metal hydride secondary battery according to one embodiment of the invention will be described in detail.

FIGURE shows, for example, an AA-size cylindrical battery. The battery includes an exterior can 10 having a cylindrical shape with a closed bottom. The exterior can 10 has an upper end that is formed into an open end. A bottom wall of the exterior can 10 has conductivity and functions as a negative terminal. A disc-like lid plate 14 is set in the upper end of the exterior can 10 with a ring-like insulating packing 12 intervening between the lid plate 14 and the exterior can 10. The lid plate 14 has conductivity. The lid plate 14 and the insulating packing 12 are fixed to the open end of the exterior can 10 by caulking a circumferential edge of the open end of the exterior can 10.

The lid plate 14 has a gas-vent hole 16 in the center thereof. A rubber valve element 18 is set on an outer surface of the lid plate 14. The valve element 18 blocks up the gas-vent hole 16. A cylindrical positive terminal 20 with a flange is also fixed onto the outer surface of the lid plate 14. The positive terminal 20 covers the valve element 18, and at the same time, presses the valve element 18 against the lid plate 14. Accordingly, the exterior can 10 is usually airtightly closed by the lid plate 14 through the insulating packing 12 and the valve element 18. When gas is produced inside the exterior can 10, and inner pressure is increased, the valve element 18 is compressed to open the gas-vent hole 16. In result, the gas within the exterior can 10 is emitted from the exterior can 10 through the gas-vent hole 16. In short, the lid plate 14, the valve element 18 and the positive terminal 20 form a safety valve for the battery.

The exterior can 10 contains an electrode assembly 22. The electrode assembly 22 includes a positive electrode 24, a negative electrode 26, and a separator 28, each formed into a strip. The positive electrode 24, the negative electrode 26, and the separator 28 are rolled in a spiral shape. The separator 28 is sandwiched between the positive electrode 24 and the negative electrode 26. To put it differently, the positive electrode 24 and the negative electrode 26 overlap each other via the separator 28. An outermost circumference of the electrode assembly 22 is formed of a part (outermost circumferential part) of the negative electrode 26. The outermost circumferential part of the negative electrode 26 is in contact with an inner circumferential wall of the exterior can 10. The negative electrode 26 and the exterior can 10 are thus electrically connected to each other. Details of the positive electrode 24, the negative electrode 26, and the separator 28 will be described later.

A positive electrode lead 30 is accommodated in the exterior can 10. The positive electrode lead 30 is placed between one end of the electrode assembly 22 and the lid plate 14. Both ends of the positive electrode lead 30 are connected to the positive electrode 24 and the lid plate 14, respectively. Accordingly, the positive electrode 24 is electrically connected to the lid plate 14 through the positive electrode lead 30. A circular insulating member 32 is disposed between the lid plate 14 and the electrode assembly 22. The insulating member 32 has a slit that allows the positive electrode lead 30 to pass therethrough. The positive electrode lead 30 thus extends through the slit. Another circular insulating member 34 is disposed between the electrode assembly 22 and the bottom wall of the exterior can 10.

Moreover, the exterior can 10 is filled with a given amount of an alkaline electrolyte (not shown). A charge-and-discharge reaction caused between the positive electrode 24 and the negative electrode 26 progresses through the alkaline electrolyte contained in the separator 28. The alkaline electrolyte is not particularly limited in terms of kind. For example, the alkaline electrolyte may be a sodium hydroxide solution, a lithium hydroxide solution, a potassium hydroxide solution, a solution obtained by mixing two or more of these solutions, or the like. The alkaline electrolyte is not particularly limited also in terms of concentration. For example, the alkaline electrolyte may have a concentration of 8N (normal).

An applicable material for the separator 28 is, for example, unwoven fabric of polyamide fibers or unwoven fabric of polyolefin fibers such as polyethylene and polypropylene, which is provided with a hydrophilic functional group.

The positive electrode 24 includes a conductive positive electrode substrate having a porous structure and a positive electrode mixture carried in pores of the positive substrate. The positive electrode mixture includes positive electrode active material particles, various additive particles used for improving characteristics of the positive electrode 24 as needed, and a binder for binding a mixed particles of the positive electrode active material particles and the additive particles to the positive electrode substrate.

If the battery is a nickel metal hydride secondary battery, the positive electrode active material particles are nickel hydroxide particles. However, instead of the nickel hydroxide particles, it is possible to use nickel hydroxide particles contained with cobalt, zinc, cadmium or the like in the form of a solid solution. Alternatively, it is also possible to use nickel hydroxide particles coated with cobalt compound with a surface subjected to alkaline heat treatment. Neither the additive particles nor the binder is particularly limited in terms of kind. Applicable as the additive particles are not only yttrium oxide but also cobalt compounds, such as cobalt oxide, metallic cobalt, and cobalt hydroxide; zinc compounds, such as metallic zinc, zinc oxide, and zinc hydroxide; and rare-earth compounds, such as erbium oxide. Applicable as the binder are hydrophilic and hydrophobic polymers, etc.

The negative electrode 26 includes a conductive negative electrode substrate (core member). A negative electrode mixture is carried by the negative electrode substrate. The negative electrode substrate is made of a metal sheet. There are a large number of through holes distributed in the metal sheet. The negative electrode substrate may be made, for example, perforated metal sheet or a sintered sheet of metallic powder. The sintered sheet is obtained by molding metallic powder into a sheet and sintering this sheet. The negative electrode mixture includes a portion that is filled in the through holes of the negative electrode substrate and a portion that is formed in a layer covering both entire surfaces of the negative electrode substrate.

The negative electrode mixture is schematically shown in enlarged size within a circle of FIGURE. The negative electrode mixture contains hydrogen storage alloy particles 36 capable of storing and releasing hydrogen as negative electrode active material, a conductivity aid (not shown) such as carbon which is used as needed, and a binder 38 for binding hydrogen storage alloy and the conductivity aid to the negative electrode substrate. As the binder 38, hydrophilic or hydrophobic polymer may be used. The conductivity aid may be carbon black or graphite. If the active material is hydrogen, a negative electrode capacity is determined by amount of the hydrogen storage alloy. According to the invention, therefore, the hydrogen storage alloy and the negative electrode 26 are referred to also as negative active material and a hydrogen storage alloy electrode, respectively.

The hydrogen storage alloy forming the particles 36 are rare-earth-Mg—Ni-based hydrogen storage alloy. A main crystal structure of the hydrogen storage alloy is not a CaCu₅-type structure but is a superlattice structure obtained by combining AB₅-type and AB₂-type structures. A composition thereof is expressed by a general formula:

(LaₐSm_{b}Gd_{c}“A”_{d})_{1-w}Mg_{w}NiₓAl_{y}“T”_{z} (1)

In Formula (1), “A” represents at least one element selected from a group consisting of Pr, Nd, Eu, Tb, Dy, Ho, Er, Tm, Yb, Lu, Sc, Zr, Hf, Ca and Y; “T” represents at least one element selected from a group consisting of V, Nb, Ta, Cr, Mo, Mn, Fe, Co, Ga, Zn, Sn, In, Cu, Si, P and B; subscripts a, b, c and d satisfy relationship shown by a>0, b≧0, c≧0, 0.1>d≧0, and a+b+c+d=1; and subscripts w, x, y and z fall within a range shown by 0.1≦w≦0.3, 0.05≦y≦0.35, 0≦z≦0.5, and 3.2≦x+y+z≦3.8.

In the superlattice structure, the elements, which are denoted by La, Sm, Gd and “A”, and Mg are situated in a site A, whereas those denoted by Ni, Al and “T” are situated in a site B. In the present specification, among the elements occupying the site A, those denoted by La, Sm, Gd and “A” are referred to also as rare-earth components.

The hydrogen storage alloy particles 36 can be obtained, for example, as described below.

First of all, metallic materials are weighted and mixed together so as to have the above-mentioned composition. The obtained mixture is melted, for example, in a high-frequency melting furnace, and then formed into an ingot. The ingot is heated for 5 to 24 hours under inert gas atmosphere at a temperature ranging from 900 to 1200 degrees centigrade. This heat treatment makes a metal structure of the ingot into a superlattice structure made of the AB₅-type and AB₂-type structures combined together. The ingot is subsequently pulverized into particles. The particles are sieved and classified by size, to thereby obtain the hydrogen storage alloy particles 36 with desired particle size.

The nickel metal hydride secondary battery has a high capacity because the hydrogen storage alloy particles 36 contain rare-earth-Mg—Ni-based hydrogen storage alloy as a main component.

The rare-earth-Mg—Ni-based hydrogen storage alloy used in the nickel metal hydride secondary battery has a given composition containing La and Gd, and is therefore excellent in alkali resistance in a high-temperature environment. For this reason, the nickel metal hydride secondary battery, which has a hydrogen storage alloy electrode made of the hydrogen storage alloy particles 36 as the negative electrode 26, is excellent in cycle life even after being left in the high-temperature environment.

In short, the nickel metal hydride secondary battery has an excellent cycle life even if exposed to the high-temperature environment during transportation by ship or vehicle.

The invention thus provides the nickel metal hydride secondary battery that is resistant to the high-temperature environment, and such a battery has a very high industrial value.

### EMBODIMENTS

### 1. Assembly of a Battery

### Embodiment A-I

### (1) Fabrication of Negative Electrode

Raw materials of the rare-earth components were prepared. The rare-earth components contained 40 percent of La, 26 percent of Sm, 26 percent of Gd, and 8 percent of Nd in the ratio of the number of atoms. A lump of hydrogen storage alloy was produced, which contained Mg, Ni, Al and Co at the proportion of 0.80:0.20:3.4:0.1:0.1 in terms of the ratio of the number of atoms, respectively, in the raw materials of the rare-earth components. The lump was then subjected to heat treatment using an induction melting furnace. Through the heat treatment, the alloy was heated for 10 hours at a temperature of 1000 degrees centigrade in argon atmosphere, which produced an ingot of rare-earth-Mg—Ni-based hydrogen storage alloy with a superlattice structure, whose composition was indicated by (La_{0.40}Sm_{0.26}Gd_{0.26}Nd_{0.08})_{0.80}Mg_{0.20}Ni_{3.4}Al_{0.1}Co_{0.1}.

The obtained ingot was mechanically pulverized under inert gas atmosphere. Particles obtained by the pulverization were sieved, and alloy particles with a particle size ranging from 400 to 200 meshes were sorted out. Subsequently, particle size distribution of the alloy particles was measured by using a laser diffraction/scattering-method particle size distribution analyzer. As a result of the measurement, the alloy particles corresponding to 50 percent in convolution integration had an average particle size of 30 μm and a largest particle size of 45 μm.

A mixture was produced by adding 100 parts by mass of the alloy particles with 0.4 parts by mass of sodium polyacrylate, 0.1 parts by mass of carboxymethyl cellulose, and 2.5 parts by mass of a polytetrafluoro-ethylene dispersion liquid (dispersion medium: water, 60 parts by mass of solid content). The mixture was then kneaded to obtain a slurry of negative electrode mixture.

The slurry was evenly coated onto both entire surfaces of a Ni-coated iron perforated metal with a thickness of 60 μm so as to have given thickness. After the slurry was dried, the perforated metal sheet was pressed and cut. This cutting step fabricated AA-size negative electrodes for nickel metal hydride secondary battery, which contained 9.0 grams of hydrogen storage alloy per sheet.

### (2) Fabrication of Positive Electrode

A mixed solution of nickel sulfate, zinc sulfate, and cobalt sulfate was prepared, which had a ratio of 3 percent by mass of Zn and 1 percent by mass of Co to metallic Ni. A sodium hydroxide solution was gradually added into the mixed solution while continuing to stir, to thereby react the sodium hydroxide solution with the mixed solution. In this process, reacting pH was kept within a range of from 13 to 14, to thereby separate out nickel hydroxide particles. The nickel hydroxide particles were rinsed three times in pure water of 10 times as much amount as the nickel hydroxide particles. The nickel hydroxide particles were then dehydrated and dried.

The obtained nickel hydroxide particles were mixed with 40 percent by mass of an HPC dispersion liquid, which produced a slurry of positive electrode mixture. The slurry was subjected to drying treatment after being filled into a nickel substrate having a porous structure. The substrate was flat-rolled and cut to fabricate a positive electrode for an AA-size nickel metal hydride secondary battery.

### (3) Assembly of a Nickel Metal Hydride Secondary Battery

The negative and positive electrodes obtained in the above-descried manner were rolled in a spiral shape with a separator, which is made of polypropylene or nylon unwoven fabric, sandwiched therebetween. In result, an electrode assembly was formed. The electrode assembly was put into an exterior can. The exterior can was then filled with 2.16 ml of a potassium hydroxide solution as an alkaline electrolyte. The solution contained lithium and sodium, and had a concentration of 30 percent by mass. The exterior can was tightly sealed with a lid plate or the like. In this manner, an AA-size nickel metal hydride secondary battery shown in FIGURE was assembled. This battery had a nominal capacity of 2500 mAh.

### Embodiment A-II

A nickel metal hydride secondary battery was assembled in the same manner as in Embodiment A-I, except that the liquid amount of the alkaline electrolyte was set at 1.98 ml.

### Embodiments B-I and B-II

Nickel metal hydride secondary batteries were assembled in the same manner as in Embodiments A-I and A-II, except that the composition of the hydrogen storage alloy was (La_{0.48}Sm_{0.22}Gd_{0.22}Nd_{0.08})_{0.80}Mg_{0.20}Ni_{3.4}Al_{0.1}Co_{0.1}.

### Embodiments C-I and C-II

Nickel metal hydride secondary batteries were assembled in the same manner as in Embodiments A-I and A-II, except that the composition of the hydrogen storage alloy was (La_{0.50}Sm_{0.21}Gd_{0.21}Nd_{0.08})_{0.80}Mg_{0.20}Ni_{3.4}Al_{0.1}Co_{0.1}.

### Embodiments D-I and D-II

Nickel metal hydride secondary batteries were assembled in the same manner as in Embodiments A-I and A-II, except that the composition of the hydrogen storage alloy was (La_{0.80}Sm_{0.06}Gd_{0.06}Nd_{0.08})_{0.80}Mg_{0.20}Ni_{3.4}Al_{0.1}Co_{0.1}.

### Embodiments E-I and E-II

Nickel metal hydride secondary batteries were assembled in the same manner as in Embodiments A-I and A-II, except that the composition of the hydrogen storage alloy was (La_{0.80}Sm_{0.03}Gd_{0.09}Nd_{0.08})_{0.80}Mg_{0.20}Ni_{3.4}Al_{0.1}Co_{0.1}.

### Embodiments F-I and F-II

Nickel metal hydride secondary batteries were assembled in the same manner as in Embodiments A-I and A-II, except that the composition of the hydrogen storage alloy was (La_{0.80}Gd_{0.12}Nd_{0.08})_{0.80}Mg_{0.20}Ni_{3.4}Al_{0.1}Co_{0.1}.

### Embodiments G-I and G-II

Nickel metal hydride secondary batteries were assembled in the same manner as in Embodiments A-I and A-II, except that the composition of the hydrogen storage alloy was (La_{0.80}Gd_{0.18}Nd_{0.02})_{0.80}Mg_{0.20}Ni_{3.4}Al_{0.1}Co_{0.1}.

### Embodiments H-I and H-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.4}Al_{0.1}Co_{0.1}.

### Embodiments I-I and I-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.4}Al_{0.1}.

### Embodiments J-I and J-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.4}Al_{0.2}.

### Embodiments K-I and K-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.4}Al_{0.3}.

### Embodiments L-I and L-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.4}Al_{0.35}.

### Embodiments M-I and M-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.4}Al_{0.05}.

### Embodiments N-I and N-II

Nickel metal hydride secondary batteries were assembled in the same manner as in Embodiments A-I and A-II, except that the composition of the hydrogen storage alloy was (La_{0.80}Gd_{0.20})_{0.90}Mg_{0.10}Ni_{3.4}Al_{0.1}.

### Embodiments O-I and O-II

Nickel metal hydride secondary batteries were assembled in the same manner as in Embodiments A-I and A-II, except that the composition of the hydrogen storage alloy was (La_{0.80}Gd_{0.20})_{0.70}Mg_{0.30}Ni_{3.4}Al_{0.1}.

### Embodiments P-I and P-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.1}Al_{0.1}.

### Embodiments Q-I and Q-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.7}Al_{0.1}.

### Comparative Examples T-I and T-II

Nickel metal hydride secondary batteries were assembled in the same manner as in Embodiments A-I and A-II, except that the composition of the hydrogen storage alloy was (La_{0.40}Sm_{0.52}Nd_{0.08})_{0.80}Mg_{0.20}Ni_{3.4}Al_{0.1}Co_{0.1}.

### Comparative Examples U-I and U-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.4}Al_{0.1}.

### Comparative Examples V-I and V-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.8}Al_{0.1}.

### Comparative Examples W-I and W-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.5}.

### Comparative Examples X-I and X-II

Nickel metal hydride secondary batteries were assembled in the same manner as in Embodiments A-I and A-II, except that the composition of the hydrogen storage alloy was (La_{0.80}Gd_{0.20})_{0.95}Mg_{0.05}Ni_{3.4}Al_{0.1}.

### Comparative Examples Y-I and Y-II

Nickel metal hydride secondary batteries were assembled in the same manner as in Embodiments A-I and A-II, except that the composition of the hydrogen storage alloy was (La_{0.80}Gd_{0.20})_{0.65}Mg_{0.35}Ni_{3.4}Al_{0.1}.

### Comparative Examples Z-I and Z-II

Nickel metal hydride secondary batteries were assembled in the same manner as in Embodiments A-I and A-II, except that the composition of the hydrogen storage alloy was (La_{0.80}Gd_{0.20})_{0.80}Mg_{0.20}Ni_{3.0}Al_{0.1}.

### 2. Method of Evaluating Batteries

### (1) Activation Treatment

The batteries of Embodiments A to Q and Comparative Examples T to Z were charged at a current of 0.1 C for 16 hours as activation treatment. The batteries were then discharged at a current of 0.2 C to a final voltage of 0.5 V. This charge-and-discharge treatment was repeated twice.

“Embodiment A” represents both Embodiments A-I and A-II. The same can be applied to “Embodiments B” to “Q” and “Comparative Examples T” to “Z”.

### (2) Evaluation of Cycle Life

The batteries of Embodiments A to Q and Comparative Examples T to Z, which had been subjected to activation treatment, were repeatedly provided with charge-and-discharge treatment in which the batteries were charged at a current of 1.0 C for one hour and subsequently discharged at a current of 1.0 C to a final voltage of 0.8 V. The number of cycles before the batteries became unable to be discharged (cycle life after activation treatment) were counted. Results are shown in TABLE 1 indicating a result of Comparative Example T-I as 100.

TABLE 1 includes subscripts “a” to “d” and “w” to “z” denoting the compositions of hydrogen storage alloys, and also includes a ratio of the number of elements in site B to the number of elements in site A (B/A ratio).

(3) Evaluation of Cycle Life after High-Temperature Exposure

The batteries of Embodiments A to Q and Comparative Examples T to Z, which had been subjected to activation treatment, were preserved for one month in an atmosphere where temperature was 60 degrees centigrade. After the preservation, the batteries were subjected to charge-and-discharge treatment in which the batteries were charged at a current of 1.0 C for one hour and subsequently discharged at a current of 1.0 C to a final voltage of 0.8 V. The number of cycles before the batteries became unable to be discharged (cycle life after high-temperature exposure) was counted. Results are shown in TABLE 1 in which a result of cycle life of Comparative Example T-I after the activation treatment is indicated as 100.

TABLE 1

| | | | | | | | | | | I | | II | |
|---|---|---|---|---|---|---|---|---|---|---|---|---|---|
| | | | | | | | | | | (Electrolyte 2.16 ml) | | (Electrolyte 1.98 ml) | |
| | | | | | | | | | | Cycle life | Cycle life | Cycle life | Cycle life |
| | | | | | | | | | | after | after high- | after | after high- |
| | Subscripts | | | | | | | | B/A | activation | temperature | activation | temperature |
| | a | b | c | d | w | x | y | z | ratio | treatment | exposure | treatment | exposure |
| Embodiment A | 0.4 | 0.26 | 0.26 | 0.08 | 0.2 | 3.4 | 0.1 | 0.1 | 3.6 | 110 | 85 | 100 | 78 |
| Embodiment B | 0.48 | 0.22 | 0.22 | 0.08 | 0.2 | 3.4 | 0.1 | 0.1 | 3.6 | 112 | 88 | 102 | 80 |
| Embodiment C | 0.5 | 0.21 | 0.21 | 0.08 | 0.2 | 3.4 | 0.1 | 0.1 | 3.6 | 113 | 91 | 103 | 83 |
| Embodiment D | 0.8 | 0.06 | 0.06 | 0.08 | 0.2 | 3.4 | 0.1 | 0.1 | 3.6 | 113 | 91 | 103 | 84 |
| Embodiment E | 0.8 | 0.03 | 0.09 | 0.08 | 0.2 | 3.4 | 0.1 | 0.1 | 3.6 | 115 | 94 | 105 | 88 |
| Embodiment F | 0.8 | 0 | 0.12 | 0.08 | 0.2 | 3.4 | 0.1 | 0.1 | 3.6 | 115 | 94 | 106 | 89 |
| Embodiment G | 0.8 | 0 | 0.18 | 0.02 | 0.2 | 3.4 | 0.1 | 0.1 | 3.6 | 118 | 98 | 110 | 95 |
| Embodiment H | 0.8 | 0 | 0.2 | 0 | 0.2 | 3.4 | 0.1 | 0.1 | 3.6 | 118 | 100 | 110 | 98 |
| Embodiment I | 0.8 | 0 | 0.2 | 0 | 0.2 | 3.4 | 0.1 | 0 | 3.5 | 118 | 108 | 110 | 103 |
| Embodiment J | 0.8 | 0 | 0.2 | 0 | 0.2 | 3.4 | 0.2 | 0 | 3.6 | 125 | 115 | 116 | 110 |
| Embodiment K | 0.8 | 0 | 0.2 | 0 | 0.2 | 3.4 | 0.3 | 0 | 3.7 | 130 | 120 | 120 | 115 |
| Embodiment L | 0.8 | 0 | 0.2 | 0 | 0.2 | 3.4 | 0.35 | 0 | 3.75 | 132 | 122 | 122 | 120 |
| Embodiment M | 0.8 | 0 | 0.2 | 0 | 0.2 | 3.5 | 0.05 | 0 | 3.55 | 100 | 75 | 90 | 60 |
| Embodiment N | 0.8 | 0 | 0.2 | 0 | 0.1 | 3.4 | 0.1 | 0 | 3.5 | 105 | 80 | 95 | 73 |
| Embodiment O | 0.8 | 0 | 0.2 | 0 | 0.3 | 3.4 | 0.1 | 0 | 3.5 | 105 | 80 | 95 | 72 |
| Embodiment P | 0.8 | 0 | 0.2 | 0 | 0.2 | 3.1 | 0.1 | 0 | 3.2 | 108 | 82 | 98 | 75 |
| Embodiment Q | 0.8 | 0 | 0.2 | 0 | 0.2 | 3.7 | 0.1 | 0 | 3.8 | 110 | 84 | 99 | 77 |
| Comparative Example T | 0.4 | 0.52 | 0 | 0.08 | 0.2 | 3.4 | 0.1 | 0.1 | 3.6 | 100 | 70 | 90 | 20 |
| Comparative Example U | 0.8 | 0 | 0.2 | 0 | 0.2 | 3.4 | 0.4 | 0 | 3.8 | 80 | 60 | 70 | 50 |
| Comparative Example V | 0.8 | 0 | 0.2 | 0 | 0.2 | 3.8 | 0.1 | 0 | 3.9 | 78 | 60 | 68 | 48 |
| Comparative Example W | 0.8 | 0 | 0.2 | 0 | 0.2 | 3.5 | 0 | 0 | 3.5 | 60 | 30 | 45 | 10 |
| Comparative Example X | 0.8 | 0 | 0.2 | 0 | 0.05 | 3.4 | 0.1 | 0 | 3.5 | 75 | 58 | 63 | 35 |
| Comparative Example Y | 0.8 | 0 | 0.2 | 0 | 0.35 | 3.4 | 0.1 | 0 | 3.5 | 77 | 60 | 64 | 40 |
| Comparative Example Z | 0.8 | 0 | 0.2 | 0 | 0.2 | 3 | 0.1 | 0 | 3.1 | 81 | 62 | 70 | 55 |

### 3. Results of Battery Evaluation

TABLE 1 evidently shows the following matters.

(1) Compared to Comparative Example T in which the rare-earth-Mg—Ni-based hydrogen storage alloy contains La, Sm and Nd as rare-earth-based components, Embodiment A, in which the rare-earth-Mg—Ni-based hydrogen storage alloy further contains Gd as a rare-earth-based component, provides a longer cycle life after activation treatment and after high-temperature exposure, regardless of the amount of electrolyte.

A possible reason for this is that the Gd contained in the rare-earth-Mg—Ni-based hydrogen storage alloy improved the rare-earth-Mg—Ni-based hydrogen storage alloy in corrosion resistance, and discouraged the alkaline electrolyte consumption taking place along with a charge-and-discharge cycle.

(2) Compared to Embodiment A, Embodiments B and C, in which a ratio of La to the sum of Sm and Gd is increased, have a still longer cycle life after activation treatment and after high-temperature exposure. Especially the cycle life after high-temperature exposure is fairly long. A possible reason will be described below.

The cycle life after activation treatment is affected more by electrolyte consumption than by the corrosion resistance of alloy, that is, the electrolyte consumption accompanying the alloy pulverization and the expansion of the positive electrode, which both result from the repeated charge and discharge. Difference in the corrosion resistance of alloy does not much affect difference in the cycle life after activation treatment.

To the contrary, if the battery is left in the high-temperature environment, the electrolyte is solely consumed due to alloy corrosion, and the consumption amount of electrolyte is determined only by the corrosion resistance of alloy. In Embodiments B and C using the alloy with higher corrosion resistance, even if the battery is left in the high-temperature environment, the reduction amount of electrolyte is discouraged. Compared to Embodiment A, Embodiments B and C offer a longer cycle life after high-temperature exposure.

Subscripts a, b and c therefore preferably satisfy relationship expressed by a>b+c. Subscript a is preferably 0.5 or more.

(3) As to Embodiments D, E and F, examination is made on a ratio between Sm and Gd. As is apparent from Embodiments D, E and F, if the ratio of Gd to Sm is high, the cycle life after activation treatment and the cycle life after high-temperature exposure are both increased.

To be more concrete, Embodiment E in which the Gd content is higher than the Sm content provides a longer cycle life after activation treatment and after high-temperature exposure than Embodiment D in which the Gd and Sm contents are equal. However, in Embodiment F that reduces the Sm content to zero and increases the Gd content more than Embodiment E, the cycle life after activation treatment and the cycle life after high-temperature exposure are not as long as those in Embodiment E. As for the cycle life, it is preferable that the Gd content be higher than the Sm content (b<c) in terms of the ratio of the number of atoms. If the Gd content is higher than the Sm content, it is not particularly necessary to limit a ratio of the Gd content to the Sm content.

(4) Regarding Embodiments F, G and H, examination is made on the contents of the elements other than La and Sm, that is, the Gd content and the content of Nd as an element shown by “A” in the general formula (I). Compared to Embodiment F in which subscript d representing the Nd content is 0.08, Embodiments G and H in which subscript d representing the Nd content is 0.02 or less provide a longer cycle life after activation treatment and after high-temperature exposure. This result shows that subscript d is preferably 0.08 or less. It is more preferable that subscript d be 0.02 or less.

If subscript d is 0.1 or more, the cycle life is reduced. Subscript d is therefore set below 0.1.

(5) As for Embodiments H and I, Co content is examined. Compared to Embodiment H in which subscript z representing the Co content is 0.1, Embodiment I provides a longer cycle life after high-temperature exposure since subscript z is zero, and Co is not contained.

It can be then considered that the rare-earth-Mg—Ni-based hydrogen storage alloy having the composition shown in the general formula (I) preferably does not contain Co.

If “T” represents an element other than Co, subscript z preferably falls in a range of from 0 to 0.3.

(6) As to Embodiments I, J, K, L and M, and Comparative Examples U and W, examination is made on Al content. In Embodiments I, J, K, L and M where subscript y representing the Al content is 0.1, 0.2, 0.3, 0.35 and 0.05, respectively, the cycle life after activation treatment and the cycle life after high-temperature exposure are fairly long, as compared to Comparative Examples U and W in which subscript y is 0.4 and 0, respectively.

For this reason, subscript y representing the Al content preferably ranges from 0.05 to 0.35, or more preferably, from 0.10 to 0.30.

(7) As to Embodiments I, N and O, and Comparative Examples X and Y, examination is made on Mg content. In Embodiments I, N and O where subscript w representing the Mg content is 0.2, 0.1 and 0.3, respectively, the cycle life after activation treatment and the cycle life after high-temperature exposure are fairly long, as compared to Comparative Examples X and Y in which subscript w is 0.05 and 0.35, respectively.

For this reason, subscript w representing the Mg content is required to be set within a range of from 0.10 to 0.30.

(8) As to Embodiments P and Q, and Comparative Examples V and Z, examination is made on a B/A ratio. In Embodiments P and Q where the B/A ratio is 3.2 and 3.8, respectively, the cycle life after activation treatment and the cycle life after high-temperature exposure are fairly long, as compared to Comparative Examples V and Z in which the B/A ratio is 3.9 and 3.1, respectively. For this reason, the B/A ratio is set within a range of from 3.2 to 3.8, or more preferably, from 3.3 to 3.5.
(9) As to Embodiments A to Q and Comparative Examples T to Z, it is examined how battery characteristics are changed on the basis of relationship between the composition of the rare-earth-Mg—Ni-based hydrogen storage alloy and the electrolyte amount.

If alloy compositions are the same, Type I (electrolyte 2.16 ml) having more electrolyte amount provides a longer cycle life after activation treatment and after high-temperature exposure. In Embodiments A to Q, both the cycle life after activation treatment and the cycle life after high-temperature exposure are long as a whole although there is more or less dispersion attributable to difference in electrolyte amount.

In order to achieve the high capacity of the battery by increasing the volume of the positive electrode, and to improve the quality of the battery by increasing the thickness of the separator, it is required to reduce space within the exterior can, into which the alkaline electrolyte is injected. To that end, Embodiments A-II to Q-II are preferable to Embodiments A-I to Q-I. In other words, it is preferable to satisfy a formula Y/X≦0.23 when the mass of the hydrogen storage alloy contained in the hydrogen storage alloy electrode is X g, and the volume of the alkaline electrolyte is Y ml.

If the amount of the alkaline electrolyte is reduced too much, the alkaline electrolyte runs short, regardless of whether or not the hydrogen storage alloy is corroded. It is then preferable to satisfy a formula Y/X>0.15.

(10) In Comparative Examples T to Z, both the cycle life after activation treatment and the cycle life after high-temperature exposure are short as a whole. In Comparative Examples T-II to Z-II that use small electrolyte amounts and use alloys having low corrosion resistance, the cycle life after high-temperature exposure is rather short, and the batteries do not function as nickel metal hydride secondary batteries anymore.

A reason for such a result can be considered that, when the alloy with low corrosion resistance is used as described, the alkaline electrolyte is consumed to corrode the alloy, which makes the alkaline electrolyte insufficient faster in Comparative Examples where the initial amount of electrolyte is small. Especially when the battery is left in the high-temperature environment, the consumption amount of the alkaline electrolyte is increased during the high-temperature exposure. Consequently, if the initial electrolyte amount is small, the alkaline electrolyte quickly runs short.

The invention is not limited to the one embodiment and the embodiments, and may be modified in various ways. For example, the nickel metal hydride secondary battery may be a square battery, and a mechanical structure is not particularly limited.

Needless to say, the hydrogen storage alloy and the hydrogen storage alloy electrode of the invention are applicable to other articles than a nickel metal hydride secondary battery.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. Hydrogen storage alloy comprising:
a composition expressed by a general formula:
(LaₐSm_{b}Gd_{c}“A”_{d})_{1-w}Mg_{w}NiₓAl_{y}“T”_{z}
where “A” represents at least one element selected from a group consisting of Pr, Nd, Eu, Tb, Dy, Ho, Er, Tm, Yb, Lu, Sc, Zr, Hf, Ca and Y;
“T” represents at least one element selected from a group consisting of V, Nb, Ta, Cr, Mo, Mn, Fe, Co, Ga, Zn, Sn, In, Cu, Si, P and B;
subscripts a, b, c and d satisfy relationship expressed by a>0, b≧0, c>0, 0.1>d≧0, and a+b+c+d=1; and
subscripts w, x, y and z fall within a range shown by 0.1≦w≦0.3, 0.05≦y≦0.35, 0≦z≦0.5, and 3.2≦x+y+z≦3.8.

2. The hydrogen storage alloy according to claim 1, wherein the “A” is Nd.

3. The hydrogen storage alloy according to claim 2, wherein the subscripts a, b and c satisfy relationship expressed by a>b+c.

4. The hydrogen storage alloy according to claim 3, wherein the subscript a is 0.5 or more.

5. The hydrogen storage alloy according to claim 4, wherein the subscripts b and c satisfy relationship expressed by b<c.

6. The hydrogen storage alloy according to claim 5, wherein the subscript d is 0.08 or less.

7. A hydrogen storage alloy electrode comprising:
a core member having conductivity; and
a particle that is made of hydrogen storage alloy carried by the core member, wherein
the particle has a composition expressed by a general formula:
(LaₐSm_{b}Gd_{c}“A”_{d})_{1-w}Mg_{w}NiₓAl_{y}“T”_{z}
where “A” represents at least one element selected from a group consisting of Pr, Nd, Eu, Tb, Dy, Ho, Er, Tm, Yb, Lu, Sc, Zr, Hf, Ca and Y;
“T” represents at least one element selected from a group consisting of V, Nb, Ta, Cr, Mo, Mn, Fe, Co, Ga, Zn, Sn, In, Cu, Si, P and B;
subscripts a, b, c and d satisfy relationship expressed by a>0, b≧0, c>0, 0.1>d≧0, and a+b+c+d=1; and
subscripts w, x, y and z fall within a range shown by 0.1≦w≦0.3, 0.05≦y≦0.35, 0≦z≦0.5, and 3.2≦x+y+z≦3.8.

8. The hydrogen storage alloy electrode according to claim 7, wherein
the “A” is Nd.

9. The hydrogen storage alloy electrode according to claim 8, wherein
the subscripts a, b and c satisfy relationship expressed by a>b+c.

10. The hydrogen storage alloy electrode according to claim 9, wherein
the subscript a is 0.5 or more.

11. The hydrogen storage alloy electrode according to claim 10, wherein
the subscripts b and c satisfy relationship expressed by b<c.

12. The hydrogen storage alloy electrode according to claim 11, wherein
the subscript d is 0.08 or less.

13. A nickel metal hydride secondary battery comprising:
a hydrogen storage alloy electrode as a negative electrode;
a positive electrode; and
an alkaline electrolyte, wherein
the hydrogen storage alloy electrode includes:
a core member having conductivity; and
a particle that is made of hydrogen storage alloy carried by the core member, wherein
the hydrogen storage alloy has a composition expressed by a general formula:
(LaₐSm_{b}Gd_{c}“A”_{d})_{1-w}Mg_{w}NiₓAl_{y}“T”_{z}
where “A” represents at least one element selected from a group consisting of Pr, Nd, Eu, Tb, Dy, Ho, Er, Tm, Yb, Lu, Sc, Zr, Hf, Ca and Y;
“T” represents at least one element selected from a group consisting of V, Nb, Ta, Cr, Mo, Mn, Fe, Co, Ga, Zn, Sn, In, Cu, Si, P and B;
subscripts a, b, c and d satisfy relationship expressed by a>0, b≧0, c>0, 0.1>d≧0, and a+b+c+d=1; and
subscripts w, x, y and z fall within a range shown by 0.1≦w≦0.3, 0.05≦y≦0.35, 0≦z≦0.5, and 3.2≦x+y+z≦3.8.

14. The nickel metal hydride secondary battery according to claim 13, wherein
the “A” is Nd.

15. The nickel metal hydride secondary battery according to claim 14, wherein
the subscripts a, b and c satisfy relationship expressed by a>b+c.

16. The nickel metal hydride secondary battery according to claim 15, wherein
the subscript a is 0.5 or more.

17. The nickel metal hydride secondary battery according to claim 16, wherein
the subscripts b and c satisfy relationship expressed by b<c.

18. The nickel metal hydride secondary battery according to claim 17, wherein
the subscript d is 0.08 or less.

19. The nickel metal hydride secondary battery according to claim 13, wherein
a formula Y/X≦0.23 is satisfied when the mass of the hydrogen storage alloy contained in the hydrogen storage alloy electrode is X g, and the volume of the alkaline electrolyte is Y ml.
